(19) United States
(12) Patent Application Publication
(10) Pub. No.: US 2016/0155055 A1
(43) Pub. Date: Jun. 2, 2016

(54) Method of Operating a Solution Searching System and Solution Searching System

(71) Applicants: Inventec (Pudong) Technology Corp., Shanghai (CN); Inventec Corporation, Taipei (TW)

(72) Inventor: Ying-Chih Lu, Taipei (TW)

(21) Appl. No.: 14/751,144

(22) Filed: Jun. 26, 2015

(30) Foreign Application Priority Data
Nov. 27, 2014 (CN) 201410707235.4

(51) Int. Cl. G06N 5/04; G06N 99/00

(52) U.S. Cl. CPC G06N 5/04; G06N 99/005

(57) ABSTRACT

A solution searching system includes a utility server, a model running server, a database server, and a central controller server. The utility server is configured to generate a first model input file according to a first issue description file. The model running server is configured to generate a first solution key according to the first model input file and a prediction model. The database server is configured to read a first solution from a database according to the first solution key. The controller central server is configured to transfer the first issue description file to the utility server, to transfer the first model input file to the model running server, to transfer the first solution key to the database server, and to output the first solution when receiving the first issue description file.

### BACKGROUND OF THE INVENTION

1. Field of the Invention

The present invention relates to a solution searching system, and more particularly, to a solution searching system using techniques of big data and data mining.

2. Description of the Prior Art

The success of a product may not only require technical research and design, but also great efforts of testing for ensuring the stability of the product. Especially for high-tech products that require high stability and high reliability, such as industrial instruments, mobile devices, work stations, personal computers or servers, the standard for quality test is even stricter. When the products are examined have issues, it maybe needed to reproduce the issues, collect and analyze the related information, find out the root causes, propose solutions and to test the proposed solutions before one can actually confirm that the examined issues are solved. These processes can be time consuming and may cause the products late to market. Also, the processes may be dependent on the engineer's profession and experience. Namely, the degree of the engineer's profession and experience can largely affect the time required for the issue to be solved and also affect the quality of the solution. Therefore, the quality of the solutions is difficult to control. In addition, since it can be difficult to extend one's personal experience to another, it may require different engineers doing the same above processes to solve the same or similar issues, which can be very inefficient and cannot ensure that the engineer will find out the best solution all the time.

Moreover, for products of the same types, the possibility to find the same or similar issues can be rather high. Although the solutions may also be recorded or stored in some prior arts, it is still difficult to store the information systematically for the great variety of different issues, the great amount of data, and the different ways of the engineers to describe the issues. Therefore, the engineers still have difficulty finding the related solutions in practical, and the goal to share the engineer's experience still has way to go. How to let the engineers share their experiences with each other, find the possible solutions easily and improve the quality of solutions have become a critical issue.

### SUMMARY OF THE INVENTION

One embodiment of the present invention discloses a solution searching system. The solution searching system comprises a utility server, a model running server, a database, a database server, and a central controller server. The utility server is configured to generate a first model input file according to a first issue description file. The model running server is configured to generate a first solution key according to the first model input file and a prediction model. The database server is configured to read a first solution file from the database according to the first solution key. The central controller server is configured to transfer the first issue description file to the utility server when receiving the first issue description file, to transfer the first model input file generated by the utility server to the model running server, to transfer the first solution key generated by the model running server to the database server, and to output the first solution file read by the database server from the database.

One embodiment of the present invention discloses a method of operating a solution searching system. The solution searching system comprises a utility server, a model running server, a database, a database server, and a central controller server. The method comprises: the central controller server transferring a first issue description file to the utility server when the central controller server receives the first issue description file, the utility server generating a first model input file according to the first issue description file, the central controller server transferring the first model input file to the model running server, the model running server generating a first solution key according to the first model input file and a prediction model, the central controller server transferring the first solution key to the database server, the database server reading a first solution file from the database according to the first solution key, and the central controller server outputting the first solution file read by the database server from the database.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a solution searching system according to one embodiment of the present invention.

FIG. 2 shows a solution searching system according to another embodiment of the present invention.

FIG. 3 shows a method of operating a solution searching system according to one embodiment of the present invention.

FIG. 4 shows a method of operating a solution searching system according to another embodiment of the present invention.

### DETAILED DESCRIPTION

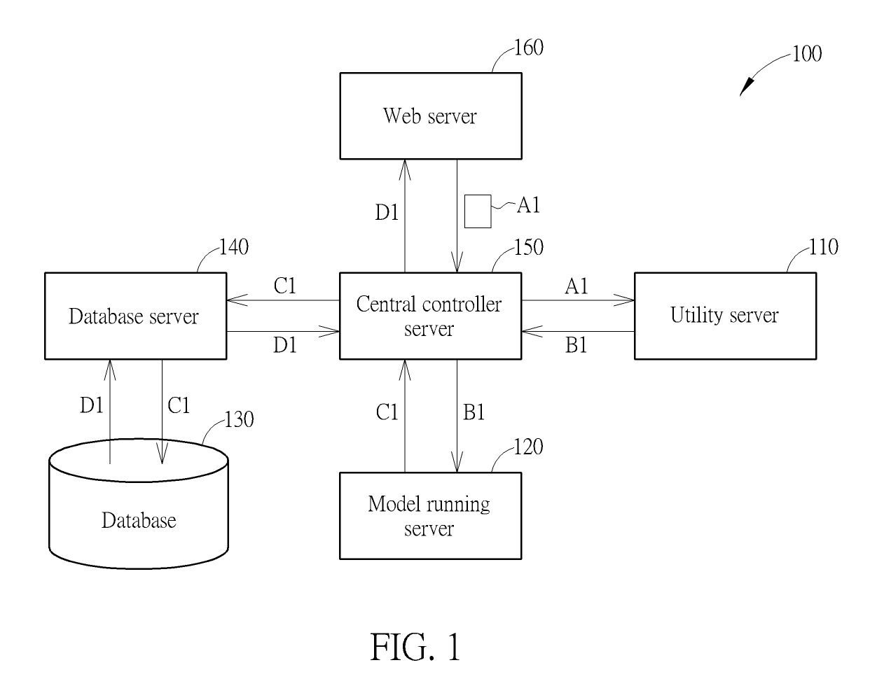

FIG. 1 shows a solution searching system 100 according to one embodiment of the present invention. The solution searching system 100 includes a utility server 110, a model running server 120, a database 130, a database server 140, and a central controller server 150. The utility server 110 can generate a first model input file B1 according to a first issue description file A1. The first issue description file A1 is an issue description file for the issue that has not been solved. The first issue description file A1 can be configured to describe the information about the system issue of the product with words. The information may include the description of the system issue and phenomenon, sub system which the system issue belongs to, and the situation in which the issue is observed, namely how to reproduce the issue, but not limited to the information aforesaid. In one embodiment of the present invention, the first issue description file A1 can use a fixed text format, for example, but not limited to, the text formats of csv, json, or xml, to list the information about the system issue so that the utility server 110 can read the first issue description file A1 more accurately to generate the first model input file B1. In other embodiments of the present invention, the first issue description file A1 can also use a non-fixed text format to list the information of the system issue.

In one embodiment of the present invention, the utility server 110 can generate an attribute description file according to the words in the first issue description file A1. The attribute description file may be composed of a plurality of attributes. Each attribute may comprise a name of the attribute and a value of the attribute. In one embodiment of the present invention, this can be described in the text format of json. When the first issue description file A1 is using a non-fixed text format to list the information about the system issues, the utility server 110 can use a regular expression to identify the name of the attribute and to get the value of the attribute. Furthermore, the utility server 110 can generate the attribute description file by referencing a standard wording table to the words in the first issue description file A1. Table 1 shows parts of the standard wording table according to one embodiment of the present invention. According to the standard wording table, the words and phrases that have the same meaning can be standardized so the expression of the syntax in the attribute description file can be more efficient. In addition, to avoid the ambiguity of the syntax in the attribute description file, all the value of the attribute may be represented with lowercase.

TABLE 1

| | |
|---|---|
| “chip set” | “cs” |
| “chipset” | “cs” |
| “operation system” | “os” |
| “operation systems” | “os” |
| “system board” | “sb” |
| “mother board” | “sb” |

After completing the attribute description file, the utility server 110 can pick up some of predictors from the attribute description file to generate the predictor file and generate the first input model file B1 according to the predictor file and the prediction model. For example, the utility server 110 can adjust the predictor file by removing the numbers in the predictor file according to the characteristic of the prediction model (ex., CBayes model) so the first model input file B1 can be generated. However, this is not to limit the present invention. In other embodiments of the present invention, the different prediction model may have different requirements for the formats.

The model running server 120 can generate a first solution key C1 according to the first model input file B1 and the prediction model, and the database server 140 can read a first solution file D1 from the database 130 according to the first solution key C1. The central server 150 can transfer the first issue description file A1 to the utility server 110 when receiving the first issue description file A1, transfer the first model input file B1 generated by the utility server 110 to the model running server 120, transfer the first solution key C1 generated by the model running server 120 to the database server 140, and output the first solution file D1 read by the database server 140 from the database 130. In one embodiment of the present invention, the database server 140 and the database 130 can be servers and databases that can support systems of Hadoop Distribute File System (HDFS), Hadoop Map/Reduce, Hive or other database systems that are suitable for managing big data so the requirements of the solution searching system 100 for processing or storing big amounts of data rapidly can be achieved. The solution searching system 100 can also include a relational database or a general file system. The relational database, such as MySql or PostgreSql, is based on general file system for the central controller server 150 to store temporary and small amounts of data.

Furthermore, the solution searching system 100 can further include web server 160. The web server 160 can provide a web page interface for the user to input the first issue description file A1. After receiving the first issue description file A1, the web server 160 can transfer the first issue description file A1 to the central controller server 150, and display the first solution file D1 outputted by the central controller server 150 on the web page interface.

According to the embodiments of the present invention, the solution searching system 100 can help the engineers to share their experiences on how they solve the system issues before, search the possible solutions easily to save time, and can also improve the quality of the solutions.

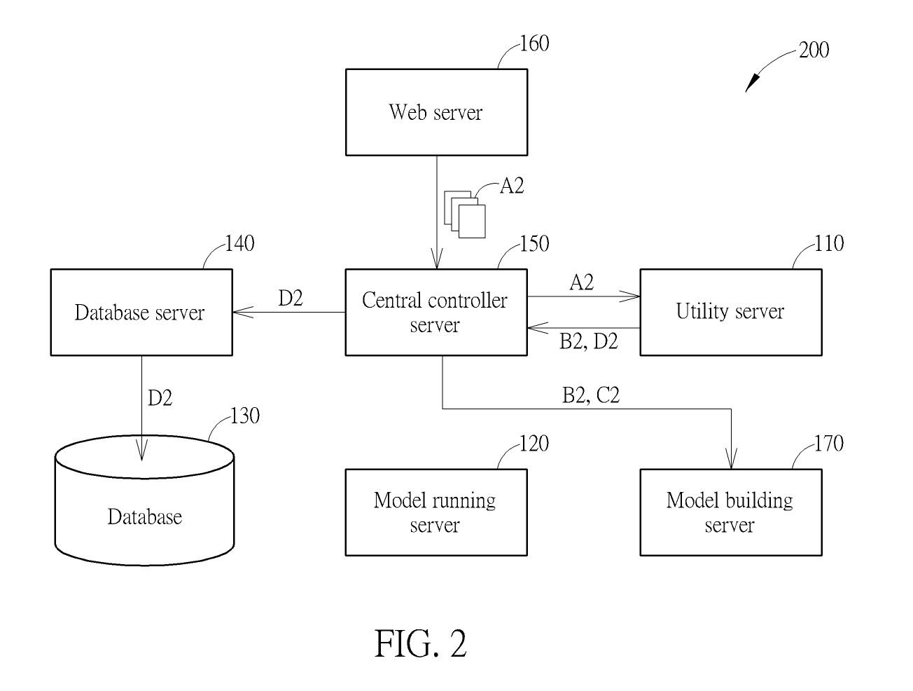

In the embodiment in FIG. 1, the prediction model used by the model running server 120 can be stored in the system in advance; however, in another embodiment of the present invention, the solution searching system can also be configured to build the prediction model. FIG. 2 shows a solution searching system 200 according to one embodiment of the present invention. The solution searching system 200 can follow the same principles of operations of the solution searching system 100. However, the solution searching system 200 further includes a model building server 170. When central controller server 150 of the solution searching system 200 receives a plurality of solved second issue description files A2, the central controller server 150 can transfer the plurality of solved second issue descriptions files A2 to the utility server 110. Each of the plurality of solved second issue description files A2 can have the same format as the first issue description file A1. In addition to columns for recording the information about the system issue, such as the description of the system issue and phenomenon, the sub system which the system issue belongs to, and the situation in which the issue is observed, each of the plurality of solved second issue description files A2 may further include a column of the root cause of the system issue, a column of solution instruction and a column of the solution key.

After receiving the plurality of solved second issue description files A2, the utility server 110 can generate second model input files B2 and second solution files D2 corresponding to each of the plurality of solved second issue description files A2 respectively according to the plurality of solved second issue description files A2. The central controller server 150 can transfer the second solution files D2 corresponding to each of the plurality of solved second issue description files A2 to the database server 140. The database server 140 can store the second solution files D2 according to the second solution key C2 included in each of the second solution files D2. Meanwhile, the central controller server 150 can transfer the second model input files B2 and second solution keys C2 corresponding to each of the plurality of solved second issue description files A2 to the model building server 170 to make the model building server 170 build the prediction model according to the second model input files B1 and the second solution keys C2 corresponding to each of the plurality of solved second issue description files A2. The model building server 170 can build the prediction model with a chosen data mining algorithm among different data mining algorithms. In one embodiment of the present invention, the model building server 170 can use the data mining algorithm such as Bayes, CBayes or SGD to build the prediction model.

In one embodiment of the present invention, the utility server 110 can generate the second solution files D2 corresponding to each of the second issue description files A2 according to the words in each of the second issue description files A2, such as the column for recording the sub system which the system issue belongs to (ex., bios, bmc, power, thermal, mechanical, hardware, os, driver, and etc.), the column of root cause of the system issue and the column of solution instruction. Each of the second solution files D2 may include the second solution key C2, the column of solution instruction and the column of root cause. In one embodiment of the present invention, the column of solution instruction can store an address, ex., a web link address, storing an instruction document, instead of directly storing the detail procedures of the solution instruction so that the extra loading of the utility server 110 can be saved by not storing the complicated information of the solution instruction.

Although each of the second issue description files A2 may already include a corresponding solution key, the utility server 110 can further adjust the solution key of the each of the second issue description files A2 according to the information stored in other columns of each of the second issue description files A2, such as the column of root cause, the column of the sub system. For example, the solution key can be generated by deriving the key words in the column of root cause so that the solution files that have the same root cause may have the same solution key.

For example, in one embodiment of the present invention, a solution key of a second issue description file may include several sub keys, such as bios.mrc, where sub key “bios” represents that the second issue description file is related to the basic input/output system (BIOS), and the sub key “mrc” represents that the second issue description file is related to memory reference code (MRC) in the basic input/output system. The utility server 110 can expand the solution key “bios.mrc” of the second issue description file to “bios.mrc.i2c” to show that the second issue description file is related to the Inter-integrated circuit (I2C) of the memory reference code of the basic input/output system according to the information stored in other columns. Namely, when a number of sub key of a solution key is greater, the issue is categorized into more detail categories. Since the number of sub key included in a solution key may affect the speed and accuracy of the solution searching system 200, the number of sub key can be adjusted according to the system needs.

After the database server 140 stores each of the second solution files D2 to the database 130 according to the second solution key C2 of each of the second solution file D2 and the model building model server 170 finishes building the prediction model, the solution searching system 200 can use the prediction model built by the model building server 170 to search possible solutions for the system issues. In the aforesaid embodiments of the present invention, when the database server 140 reads the first solution file D1 from the database 130 according to the first solution key C1 generated by the model running server 120, the first solution file D1 read by the database server 140 can be a second solution file of the plurality of second solution files D2 that has a second solution key C2 matched with the first solution key C1. Also, a number of sub key included in the second solution key C2 matched with the first solution key C1 is no less than a number of sub key included in the first solution key C1.

In one embodiment of the present invention, in the solution searching system 200, the central controller server 150 can transfer data with the utility server 110, the database server 140, the model running server 120 and the model building server 170 by network packets and application programming interfaces (APIs) of the central controller server 150, the utility server 110, the database server 140, the model running server 120 and the model building server 170. In one embodiment of the present invention, the remote procedure call (PRC) between the APIs can be achieved by adopting the User Datagram Protocol (UDP) or Transmission Control Protocol (TCP) so that the solution searching system 200 can be constructed in a distributed manner, which is easier for system expansion and maintenance.

The solution searching system 200 can help the engineers to share their experiences on how they used to solve the system issues and help them to find the possible solutions easily by adopting the technics of big data and data mining algorithm. The time required to solve system issues is reduced and the quality of the solutions is also improve.

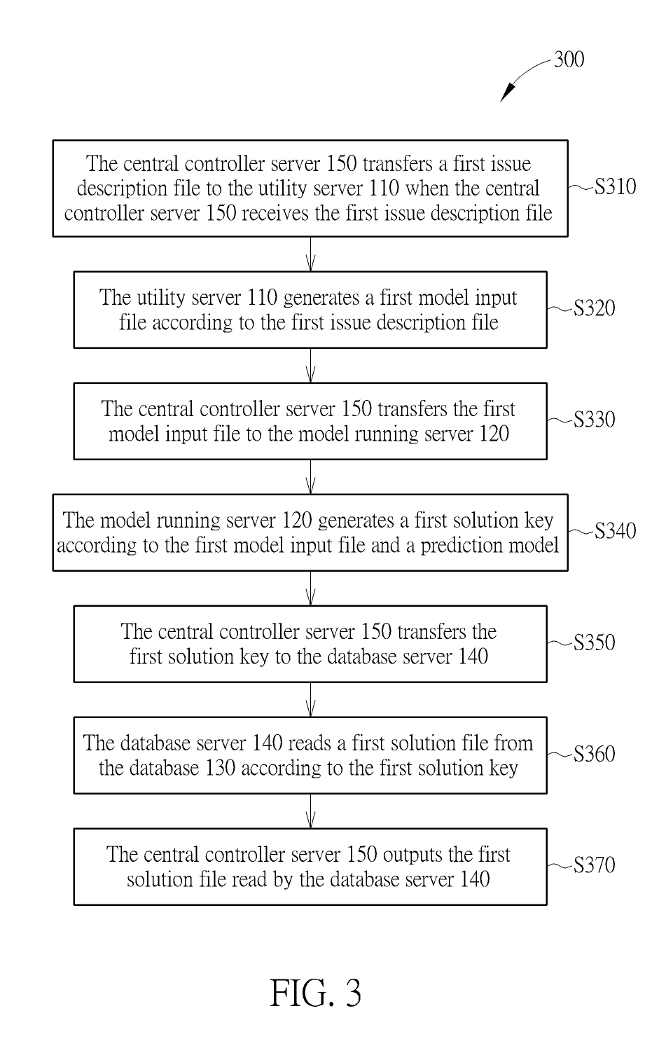

FIG. 3 shows a flowchart of a method 300 of operating the solution searching system 100 according to one embodiment of the present invention. The method 300 of operating the solution searching system includes steps S310 to S370:

S310: the central controller server 150 transfers a first issue description file to the utility server 110 when the central controller server 150 receives the first issue description file;

S320: the utility server 110 generates a first model input file according to the first issue description file;

S330: the central controller server 150 transfers the first model input file to the model running server 120;

S340: the model running server 120 generates a first solution key according to the first model input file and a prediction model;

S350: the central controller server 150 transfers the first solution key to the database server 140;

S360: the database server 140 reads a first solution file from the database 130 according to the first solution key;

S370: the central controller server 150 outputs the first solution file read by the database server 140.

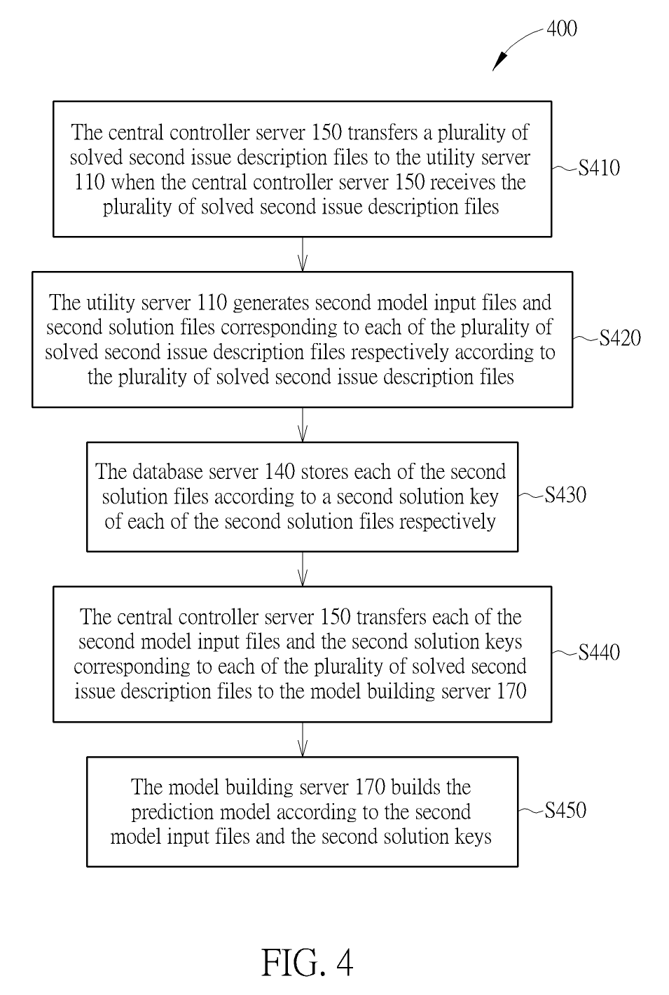

FIG. 4 shows a flowchart of a method 400 of operating the solution searching system 200 according to another embodiment of the present invention. The method 400 of operating the solution searching system includes steps S410 to S450:

S410: the central controller server 150 transfers a plurality of solved second issue description files to the utility server 110 when the central controller server 150 receives the plurality of solved second issue description files;

S420: the utility server 110 generates second model input files and second solution files corresponding to each of the plurality of solved second issue description files respectively according to the plurality of solved second issue description files;

S430: the database server 140 stores each of the second solution files according to a second solution key of each of the second solution files respectively;

S440: the central controller server 150 transfers each of the second model input files and the second solution keys corresponding to each of the plurality of solved second issue description files to the model building server 170;

S450: the model building server 170 builds the prediction model according to the second model input files and the second solution keys. corresponding to each of the plurality of solved second issue description files and a data mining algorithm.

According to the embodiments of the present invention, the solution searching systems 100 and 200 and the methods 300 and 400 can help the engineers to share their experiences on how they solve the system issues before, search the possible solutions easily to save time, and can also improve the quality of the solutions by adopting the technics of big data and data mining.

In summary, the solution searching system and the method of operating the solution searching system according to the embodiments of the present invention can adopt the database for big data and the data mining algorithms to help the users to share their experiences on how they solve the system issues before, and can help the users to search the possible solutions when the users encounter system issues. Consequently, the inefficiency of the searching system and the difficulty of controlling the quality of solution in the prior are can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A solution searching system, comprising
a utility server configured to generate a first model input file according to a first issue description file;
a model running server configured to generate a first solution key according to the first model input file and a prediction model;
a database;
a database server configured to read a first solution file from the database according to the first solution key; and
a central controller server configured to:
when receiving the first issue description file, transfer the first issue description file to the utility server;
transfer the first model input file generated by the utility server to the model running server;
transfer the first solution key generated by the model running server to the database server; and
output the first solution file read by the database server from the database.

2. The solution searching system of claim 1, wherein the central controller server is further configured to:
when receiving a plurality of solved second issue description files, transfer the plurality of solved second issue description files to the utility server to make the utility server generate second model input files and second solution files corresponding to each of the plurality of solved second issue description files respectively according to the plurality of solved second issue description files;
make the database server store each of the second solution files according to a second solution key of each of the second solution files respectively; and
transfer each of the second model input files and the second solution files corresponding to each of the plurality of solved second issue description files to a model building server to make the model building server build the prediction model according to the second model input files and the second solution keys corresponding to each of the plurality of solved second issue description files and a data mining algorithm.

3. The solution searching system of claim 2, wherein the first solution file reads by the database server from the database is a second solution file of the second solution files that has a second solution key matched with the first solution key.

4. The solution searching system of claim 3, wherein each of the first solution key and the second solution keys includes at least one sub key, and a number of sub key included in the second solution key matched with the first solution key is no less than a number of sub key included in the first solution key.

5. The solution searching system of claim 2, wherein the utility server generates the second solution files corresponding to each of the plurality of solved second issue description files respectively according to the plurality of solved second issue description files is generating the second solution files corresponding to each of the plurality of solved second issue description files respectively according to words stated in a plurality of critical columns of each of the plurality of second issue description files, wherein each of the second solution files includes the second solution key, a column of solution instruction and a column of root cause, and the column of solution instruction stores an address storing an instruction document.

6. The solution searching system of claim 2, wherein the central controller server transfers data with the utility server, the database server, the model running server and the model building server by network packets and application programming interfaces of the central controller server, the utility server, the database server, the model running server and the model building server.

7. The solution searching system of claim 1, wherein the utility server is further configured to:
generate an attribute description file according to words in the first issue description file; and
generate a predictor file according to the attribute description file;
wherein the utility server generates the first model input file according to the first issue description file is generating the first model input file according to the predictor file.

8. The solution searching system of claim 7, wherein the utility server generates the attribute description file according to the words in the first issue description file is generating the attribute description file by referencing a standard wording table to the words in the first issue description file.

9. The solution searching system of claim 1, further comprising a web server configured to provide a web page interface for receiving the first issue description file, transfer the first issue description file to the central controller server, and display the first solution outputted by the central controller server on the web page interface.

10. A method of operating a solution searching system, wherein the solution searching system comprises a utility server, a model running server, a database, a database server, and a central controller server, the method comprising:
the central controller server transferring a first issue description file to the utility server when the central controller server receives the first issue description file;
the utility server generating a first model input file according to the first issue description file;
the central controller server transferring the first model input file to the model running server;
the model running server generating a first solution key according to the first model input file and a prediction model;
the central controller server transferring the first solution key to the database server;
the database server reading a first solution file from the database according to the first solution key; and
the central controller server outputting the first solution file read by the database server from the database.

11. The method of claim 10, wherein the solution searching system further comprises a model building server, the method further comprising:
the central controller server transferring a plurality of solved second issue description files to the utility server when the central controller server receives the plurality of solved second issue description files;
the utility server generating second model input files and second solution files corresponding to each of the plurality of solved second issue description files respectively according to the plurality of solved second issue description files;
the database server storing each of the second solution files according to a second solution key of each of the second solution files respectively;
the central controller server transferring each of the second model input files and the second solution keys corresponding to each of the plurality of solved second issue description files to the model building server; and
the model building server building the prediction model according to the second model input keys and the second solution files corresponding to each of the plurality of solved second issue description files and a data mining algorithm.

12. The method of claim 11, wherein the first solution file reads by the database server from the database is a second solution file of the second solution files that has a second solution key matched with the first solution key.

13. The method of claim 12, wherein each of the first solution key and the second solution keys includes at least one sub key, and a number of sub key included in the second solution key matched with the first solution key is no less than a number of sub key included in the first solution key.

14. The method of claim 11, wherein the utility server generating the second solution files corresponding to each of the plurality of solved second issue description files respectively according to the plurality of solved second issue description files is generating the second solution files corresponding to each of the plurality of solved second issue description files respectively according to words stated in a plurality of critical columns of each of the plurality of second issue description files, wherein each of the second solution files includes the second solution key, a column of solution instruction and a column of root cause, and the column of solution instruction stores an address storing an instruction document.

15. The method of claim 10, wherein the utility server generating the first model input file according to the first issue description file further comprises:
the utility server generating an attribute description file according to words in the first issue description file;
the utility server generating a predictor file according to the attribute description file; and
the utility server generating the first model input file according to the predictor file.

16. The method of claim 15, wherein the utility server generating the attribute description file according to the words in the first issue description file is generating the attribute description file by referencing a standard wording table to the words in the first issue description file.

17. The method of claim 11, further comprising the central controller server transferring data with the utility server, the database server, the model running server and the model building server by network packets and application programming interfaces of the central controller server, the utility server, the database server, the model running server and the model building server.

18. The method of claim 10, wherein the solution searching system further comprises a web server, the method further comprising:
the web server providing a web page interface for receiving the first issue description file;
the web server transferring the first issue description file to the central controller server; and
the web server displaying the first solution outputted by the central controller server on the web page interface.
